(19) United States
(12) Patent Application Publication
(10) Pub. No.: US 2026/0113683 A1
(43) Pub. Date: Apr. 23, 2026

(54) METHOD AND APPARATUS FOR POLICY CONTROL FOR RESTRICTED PDU SESSION IN WIRELESS COMMUNICATION SYSTEM

(71) Applicant: Samsung Electronics Co., Ltd., Suwon-si, Gyeonggi-do (KR)

(72) Inventor: Naman GUPTA, Suwon-si (KR)

(21) Appl. No.: 19/116,806

(22) PCT Filed: Sep. 27, 2023
(86) PCT No.: PCT/KR2023/015045

§ 371 Date: Mar. 28, 2025

(30) Foreign Application Priority Data
Sep. 29, 2022 (KR) 10-2022-0124502

(51) Int. Cl. H04W 40/02; H04L 41/0894; H04W 60/04

(52) U.S. Cl. CPC H04W 40/02; H04L 41/0894; H04W 60/04

(57) ABSTRACT

The disclosure provides a method and apparatus for policy control for a restricted protocol data unit (PDU) session in a wireless communication system supporting a localized service. According to an embodiment, a method performed by a user equipment (UE) in a wireless communication system supporting a localized service is provided, the method comprises transmitting, to an access and mobility management function (AMF) of a hosting network providing the localized service, a first message including information related to the localized service, receiving, from the AMF, a second message including policy information related to the localized service, the policy information including UE route selection policy (URSP) rules related to the localized service, and transmitting, a session management function (SMF) via the AMF, a PDU session request message including information representing the localized service, based on the policy information.

### CROSS-REFERENCE TO RELATED APPLICATION(S)

This application is a U.S. National Stage application under 35 U.S.C. § 371 of an International application number PCT/KR2023/015045, filed on Sep. 27, 2023, which is based on and claims priority of a Korean patent application number 10-2022-0124502, filed on Sep. 29, 2022, in the Korean Intellectual Property Office, the disclosure of which is incorporated by reference herein in its entirety.

### TECHNICAL FIELD

The disclosure relates to a method and apparatus for providing a localized service in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure provides a method and apparatus for policy control for a restricted protocol data unit (PDU) session in a wireless communication system supporting a localized service.

### Technical Solution

According to an embodiment, a method performed by a user equipment (UE) in a wireless communication system supporting a localized service is provided, the method comprises transmitting, to an access and mobility management function (AMF) of a hosting network providing the localized service, a first message including information representing the localized service, receiving, from the AMF, a second message including policy information related to the localized service, the policy information including UE route selection policy (URSP) rules related to the localized service, and transmitting, to a session management function (SMF) via the AMF, a PDU session request message including information representing the localized service, based on the policy information.

According to an embodiment, a UE in a wireless communication system supporting a localized service is provided, the UE comprises a transceiver, and a processor configured to transmit, to an AMF of a hosting network providing the localized service, via the transceiver, a first message including information representing the localized service, receive, through the transceiver from the AMF, a second message including policy information related to the localized service, the policy information including URSP rules related to the localized service, and transmit, to a SMF via the AMF, a PDU session request message including information representing the localized service through the transceiver, based on the policy information.

According to an embodiment, a method performed by a policy and control function (PCF) in a wireless communication system supporting a localized service is provided, the method comprises receiving information related to localized service provision from a localized service provider (LSP) server, and generating, based on the received information, policy information related to the localized service to be provided to a user equipment (UE) using the localized service.

According to an embodiment, a method performed by an AMF of a hosting network providing a localized service in a wireless communication system is provided, the method comprises receiving, from a UE, a first message including information representing the localized service, transmitting, to a PCF, a policy request message including the information representing the localized service, receiving, from the PCF, a policy response message including policy information related to the localized service, the policy information including URSP rules related to the localized service, and transmitting, to the UE, a second message including the policy information related to the localized service.

According to an embodiment, an AMF of a hosting network providing a localized service in a wireless communication system is provided, the AMF comprises a transceiver, and a processor configured to receive, via the transceiver from a UE, a first message including information representing the localized service, transmit, to a PCF through the transceiver, a policy request message including the information representing the localized service, receive, via the transceiver from the PCF, a policy response message including policy information related to the localized service, the policy information including URSP rules related to the localized service, and transmit, to the UE through the transceiver, a second message including the policy information related to the localized service.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or, for example, the expression “A or B” may include A, may include B, or may include both A and B. “/” represents “and/or”, for example, “first/second node” represents the first node and the second node, or the first node or the second node. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates a 5G system network structure according to an embodiment;

FIG. 2 illustrates an example deployment of an hosting network providing multiple localized services according to various embodiments;

FIG. 3 illustrate an example procedure informing a UE of information about a list of localized service(s) provided by hosting network;

FIG. 4 illustrate an example procedure for establishing a restricted PDU session and obtaining corresponding policy information; and

FIG. 5 illustrates an example configuration of a network entity according to an embodiment.

### MODE FOR THE INVENTION

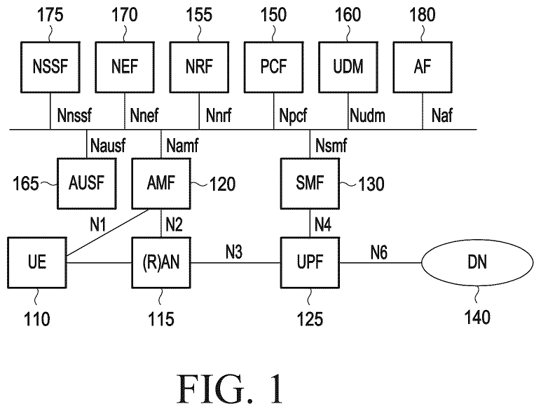

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments are described in detail with reference to the accompanying drawings. When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

For the same reasons, some elements may be exaggerated or schematically shown. The size of each element does not necessarily reflects the real size of the element. The same reference numeral is used to refer to the same element throughout the drawings.

Advantages and features of the disclosure, and methods for achieving the same may be understood through the embodiments to be described below taken in conjunction with the accompanying drawings. However, the disclosure is not limited to the embodiments disclosed herein, and various changes may be made thereto. The embodiments disclosed herein are provided only to inform one of ordinary skilled in the art of the category of the disclosure. The disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, the term “unit” is not limited as meaning a software or hardware element. A ‘unit’ may be configured in a storage medium that may be addressed or may be configured to reproduce one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. A function provided in an element or a ‘unit’ may be combined with additional elements or may be split into sub elements or sub units. Further, an element or a ‘unit’ may be implemented to reproduce one or more CPUs in a device or a security multimedia card.

Hereinafter, the base station may be an entity allocating resource to terminal and may be at least one of eNodeB (eNB), Node B, base station (BS), radio access network (RAN), access network (AN), RAN node, NR NB, gNB, wireless access unit, base station controller, or node over network. The terminal may include UE (user equipment), MS (mobile station), cellular phone, smartphone, computer, or multimedia system capable of performing communication functions. In the disclosure, downlink (DL) refers to a wireless transmission path of signal transmitted from the base station to the terminal, and uplink (UL) refers to a wireless transmission path of signal transmitted from the terminal to the base station. Further, although LTE- or LTE-A-based system is described in connection with embodiments, as an example, embodiments may also apply to other communication systems with similar technical background or channel form. Further, embodiments may be modified in such a range as not to significantly depart from the scope of the disclosure under the determination by one of ordinary skill in the art and such modifications may be applicable to other communication systems.

In the disclosure, the (communication) operator may be understood to include at least one server device capable of communicating with network entities in embodiments of the disclosure.

A unit performing each function provided by the 5G network system may be defined as a network function (NF). An example of the structure of a 5G mobile communication network is shown in FIG. 1.

FIG. 1 illustrates a view of a network structure for a 5G system according to an embodiment.

The network structure of FIG. 1 may refer to the standards (e.g., TS 23.501, TS 23.502, TS 23.503, etc.) defined by the international telecommunication union (ITU) or 3GPP, and each of the components included in the network architecture of FIG. 1 may mean a physical entity or may mean software that performs an individual function or hardware combined with software. Reference characters denoted by Nx in FIG. 1, such as N1, N2, N3, . . . , etc., indicate known interfaces between network functions (NFs) in the 5G core network (NF), and the relevant descriptions may be found in the standard specifications (TS 23.501). Therefore, a detailed description will be omitted.

Referring to FIG. 1, the network structure may include at least one of an access and mobility management function (AMF) 120 for managing network access and mobility of a user equipment (UE) 110, a session management function (SMF) 130 for performing session-related functions for the UE 110, a user plane function (UPF) 125 that is in charge of transferring user data and being controlled by the SMF 130, an application function (AF) 180 that communicates with 5GC to provide application services, a network exposure function (NEF) 170 that supports communication with the AF 180, a unified data management (UDM) 160 and a unified data repository (UDR) (not shown) for data storage and management, a policy and control function (PCF) 150 for managing policies, or a data network (DN) 140 (e.g., Internet) where user data is transferred. The UDR may store the subscription information about the UE 110 and may provide the UDM 160 with the subscription information about the UE 110. Further, the UDR may store operator policy information and may provide operator policy information to the PCF 150.

In addition to the above-described NFs, The 5G network system may further include a RAN (e.g., a base station, such as gNB) 115, an authentication server function (AUSF) 165, a network slice selection function (NSSF) 175, and a network repository function (NRF) 155. For convenience of description, network entities operated according to embodiments are referred to below by the names of network functions (NFs) (e.g., AMF, UPF, SMF, PCF, UDM, etc.). However, the embodiments may be likewise applied even when the NF is actually implemented as an instance (e.g., an AMF instance, UPF instance, SMF instance, PCF instance, or UDM instance).

In the disclosure, localized services are those which are provided at a specific or limited area and/or which may be bounded in time. These services may either be in the form of an application (E-game, on-demand audio/video etc.) or simply in the form of connectivity (UE to data network may offer better quality of service (QoS)).

Localized Service provider (LSP) server: a server of an application provider or network operator who make their services localized and to be offered to end user (e.g. UE) via a Hosting Network. The LSP server may be an AF 180 capable of communicating with the 5GC through the NEF 170 in the network structure of FIG. 1. Alternatively, the LSP server may be implemented as an NF in 5GC.

Hosting Network: a Network which Provides Access to Localized Services

Localized services provide many opportunities to users (e.g. UEs) and service providers. Dynamic relationships may be made between various 3^{rd} party service providers and the Hosting networks to provide its user particular services. The access to localized services may be provided in remote areas where regular network connectivity is not available; e.g. in a holiday camp site which is far from other infrastructure.

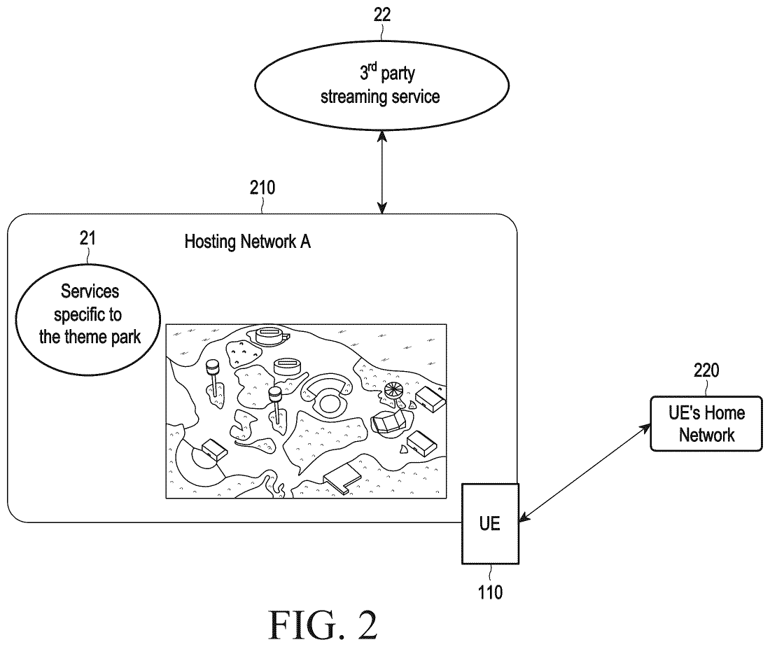

FIG. 2 illustrates an example deployment of an hosting network providing multiple localized services according to various embodiments;

FIG. 2 depicts a possible scenario. In this case, for example, a Hosting network A 210 has been deployed around a theme park. Hosting network 210 may agree to provide some services 21, 22 (for example internet/voice connectivity, or access to an locally hosted application specific to theme park; access to third party streaming services) to UE(s) which have some sort of credentials or UE(s) who want to buy/get access to the premium services.

Now suppose there is a case when UE 110 is configured only with its Home network credentials. Now UE 110 manually selects an Hosting network 210 available in its area and try to find what localized services 21, 22 are being offered by the Hosting network 210. Note although if the UE 110 may be primarily authenticated with its Home network credentials, it may be possible that UE's Home network Subscription does not allow UE 110 to access localized services 21, 22. As per the current 3GPP standardization there does not exist any mechanism by which a UE 110 may request for credentials for the localized service in an on-demand manner from the Hosting network 210 (this network may be separate from UE's home network 220). For example, the UE's home network 220 may use the network structure described with reference to FIG. 1. The Hosting network 210 may include at least one of AMF 120, SMF 130, UPF 125 and PCF 150 in the network structure described with reference to FIG. 1.

Also, an aspect for Localized service is that 3rd party localized service providers are easily able to create dynamic relationships with the Hosting network to provide Localized services.

The features of this disclosure refer to at least one of the following 1) and 2):
1) What information/policies need to be stored in the PCF 150 related to Localized services
2) How exactly will UE 110 initiate a restricted PDU session and how will Hosting network 210 connect UE 110 to the appropriate LSP server so that UE 110 may subscribe for the particular Localized service.

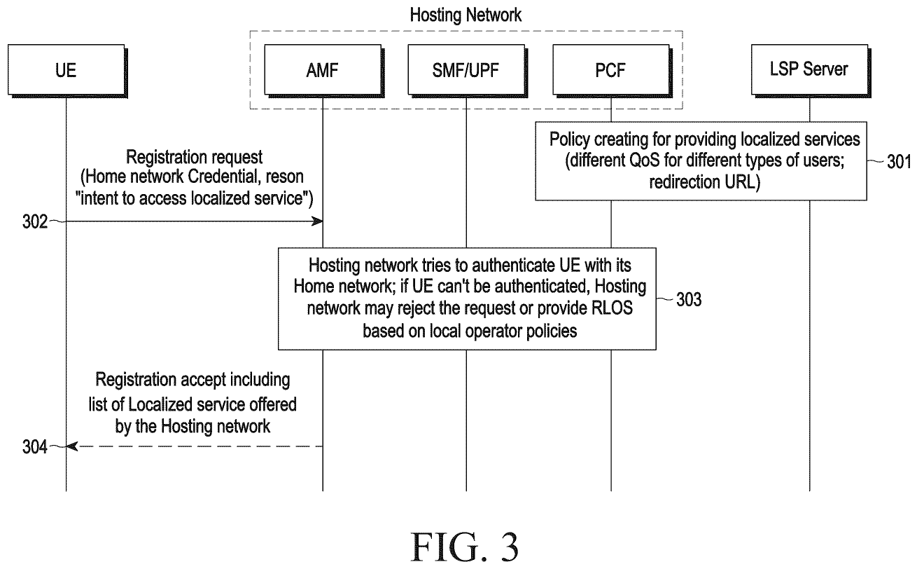

FIG. 3 illustrates an example procedure informing a UE of information about a list of localized service(s) provided by the hosting network. For basic functions of the network entities of FIG. 3 reference may be made to the above description of the corresponding network entities in FIG. 1.

FIG. 3 shows the procedure in which a 3^{rd} party localized service provider (e.g. LSP server) creates a service relationship with a Hosting network and the UE asks for available Localized services from the Hosting network. It is assumed that the UE manually selects the Hosting network and the UE does not have any prior credentials/subscription for the Hosting network nor for the Localized service provided by the Hosting network.

In operation 301, the LSP server provides Hosting network with the appropriate parameters and localized service(s) that the LSP server wants the Hosting network to provide to the UEs which has its subscription. The LSP server transmits information related to localized service provision to the PCF. The PCF creates policy information for providing the localized service(s) to the UEs based on the information related to the localized service provision. The information related to the localized service provision may include (but not limited to) at least one of the following:
redirection uniform resource locator (URL)/address of the captive portal; through which UE may subscribe for the Localized service
What QoS is to be provided to the UEs
In case the Localized service is realized via access to a particular data network name (DNN); then DNN name
Whenever applicable, application ID of the application related to the Localized service

In operation 302, the UE transmits a registration request message to the AMF of the hosting network. The registration request message includes at least one of home network credential, an indication or an reason that the registration request is to access the Localized service(s) (e.g. “intent to access localized service”); so that the Hosting network may provide appropriate information related to the Localized service(s) to the UE.

In operation 303, the Hosting Network tries to authenticate the UE using its Home network credentials. If RLOS (restricted localized operator services) is provided by the Hosting network, the UE may be registered to the hosting network without any primary authentication.

In operation 304, the UE receives a registration accept message via the AMF of the hosting network, the Hosting network provides the UE with the list information of the localized service(s) (e.g. a list of information related to localized services) through the registration accept message, per localized service the registration accept message may also include whether provisioning of credentials using restricted PDU Session is allowed or not. If the UE already has the credentials for the particular Localized service, the UE may use those credentials to authorize for that Localized service, otherwise the UE tries to obtain those credentials either:
via over the top means, by connecting to internet via some other network
or tries to get those credentials using the restricted PDU Session from the same Hosting network, in the case provisioning via the restricted PDU Session is allowed.

In the disclosure, the Restricted PDU Session may be a PDU Session that's sole purpose is that the UE may connect to the Localized service provider portal, subscribe for Localized services by, for example, providing credit card details etc.

The PDU Session may be restricted in time, total number of packets and may allow to outgoing packets only to a particular address.

Now for the UE to request establishment of the restricted PDU Session, it should be provided the appropriate UE route selection policy (URSP) rules so that the UE may request for the PDU Session for the appropriate DNN and single-network slice selection assistance information (S-NSSAI). The S-NSSAI is an identifier for identifying a network slice in the 5G system. These URSP rules will be stored per Localized service name in the PCF and will be provided to the UE via AMF. Table 1 shows an example of how corresponding Policy information may be stored and what information elements should be included in the policy information.

The following Table 1 shows information element (that is, AMF/UE policy information) specific to localized services that may be stored in the PCF. The URSP rules will be present only if the restricted PDU session may be established for provisioning purposes.

TABLE 1

| | |
|---|---|
| For each localized service provided by | Remarks |
| the Hosting network | |
| Localized service name | |
| Indication whether provisioning via | |
| restricted PDU Session is allowed | |
| Corresponding URSP rule | |

| | |
|---|---|
| Traffic descriptor | Match all |
| Route selection | DNN, S-NSSAI etc. |
| components | |

Table 2 shows the enhancements for the PDU session policies that are to be done for the restricted PDU Session for the particular Localized service. Table 2 shows information elements (SMF policy information) specific to localized services.

TABLE 2

| | |
|---|---|
| For each localized service provided by | Remarks |
| the Hosting network | |
| Localized service name | |
| Max duration of PDU Session | |
| Max data/packets through this | |
| restricted PDU Session | |
| Redirection information | address of the 3^{rd} |
| | party captive portal |
| Other QoS/bitrate related parameters | |

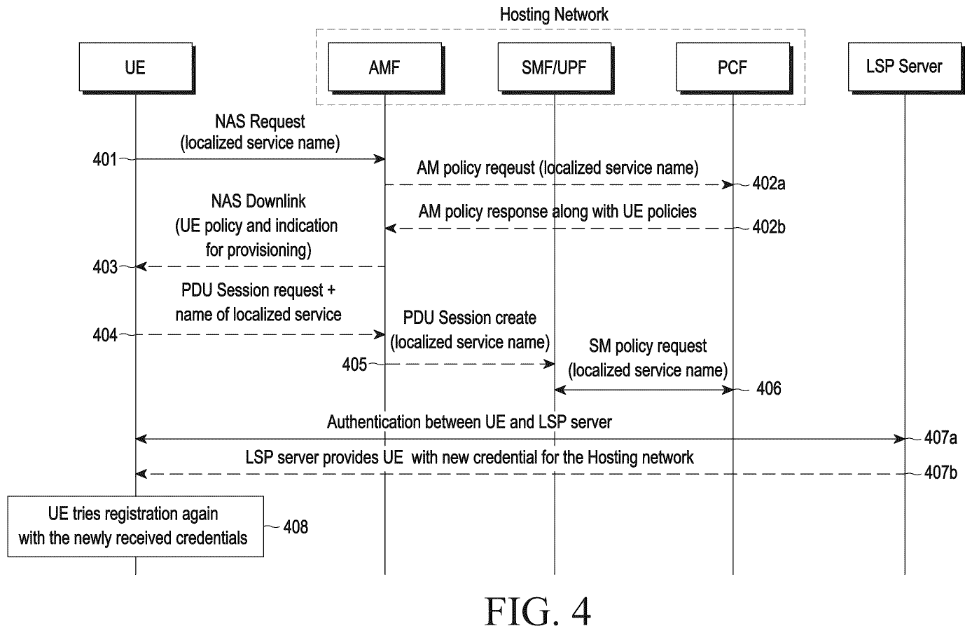

FIG. 4 illustrates an example procedure for establishing a restricted PDU session and obtaining corresponding policy information. For basic functions of the network entities of FIG. 4 reference may be made to the above description of the corresponding network entities in FIG. 1.

FIG. 4 depicts the procedure that may be performed after the UE obtains the information about the localized services provided by the Hosting network. The UE may be displayed with the list information of available localized services, and The UE may manually select one of the available localized services, to avail those particular service. The UE will then transmit, to the Hosting network, the corresponding non access stratum (NAS) request message including the name of the selected Localized service, and both Hosting network and UE will then proceed to establish the restricted PDU session for the UE to get subscribed for the particular Localized services.

In operation 401, the UE transmits the NAS Request message including information representing the selected Localized service (e.g. information on the name of the selected Localized service) to the AMF of the Hosting network.

In operation 402a, the AMF transmits, to the PCF, an AM policy request message including the information on the name of the selected Localized service. In operation 402b, the AMF receives, from the PCF, an AM policy response message including the AMF/UE policy information as exemplified in the Table 1.

In operation 403, the UE receives, from the AMF, a NAS downlink message, the NAS downlink message including the AMF/UE policy information (e.g. URSP rules, address of the captive portal of the 3rd party server etc.)

In operation 404, the UE transmits, to the AMF, a PDU session establishment request message including information on the name of the localized service, based on the URSP rules included in the AMF/UE policy information. In an alternative embodiment, an indication representing the localized service may be included instead of the information on the name of the localized service in the PDU session establishment request message.

In operation 405, the AMF transmits, to the SMF, a PDU session create message including information on the name of the localized service.

In operation 406, the SMF transmits, to the PCF, an SM policy request message including the information on the name of the localized service so as to request the SM policy information for the Restricted PDU Session for the provided Localized service name, and then the SMF receives, from the PCF, an SM policy response message including the SM policy information (as exemplified in Table 2)

In operations 407a and 407b, the Restricted PDU Session is established “by the SMF based on the stored configuration and/or the policies received from the PCF in the operation 406” between the UE and the 3rd party server (that is, LSP server). The UE may pay for the localized service and obtain, from the LSP server, the required new credentials for the Hosting network.

In operation 408, the UE may try to register again with the new credentials for the particular localized service. The Registration Request from the UE to the AMF will include the credentials for the particular localized service and will proceed similar to the usual Registration procedure as defined in current 3GPP standards.

So overall the main difference between the disclosure and the existing procedures are as follows:
1) Policy information from the PCF is requested on the basis of the Localized service name (that is Localized service name is used as a filter for getting the particular policies)
2) The PDU Session request message from the UE and the PDU Session create from AMF to the SMF may contain the Localized service name, so that the corresponding network function (NF) may request and implement appropriate policy information.

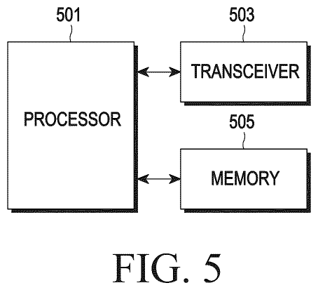

FIG. 5 illustrates an example configuration of a network entity according to an embodiment. The network entity shown in FIG. 5 may be any one of UE and network functions (e.g., a base station, AMF, SMF, UPF, PCF, and a LSP server, etc.) according to a system implementation.

Referring to FIG. 5, the network entity may include a processor 501 for controlling the overall operation of the network entity and a transceiver 503. The transceiver 503 may include a transmitter and a receiver. The transceiver 503 may be referred to as a transmission/reception unit.

The transceiver 503 may transmit/receive signals/information/messages with a UE or other network entities via a wired or wireless network according to embodiments.

The processor 501 may control the network entity to perform an operation according to any one or a combination of two or more of the above-described embodiments of FIGS. 1 to 4. Meanwhile, the processor 501 and the transceiver 503 are not necessarily implemented in separate modules but rather as a single component, e.g., a single chip. The processor 501 and the transceiver 503 may be electrically connected with each other. In an embodiment, the processor 501 may be a circuit, an application-specific circuit, or at least one processor. The operations of the network entity may be realized by including a memory 505 storing a corresponding program code in a component (e.g., the processor 501 and/or other components not shown) in the network entity.

It should be noted that the configuration views, example views of control/data signal transmission/reception methods, and example views of operational procedures of FIGS. 1 to 5 are not intended as limiting the scope of the disclosure. In other words, all the components, entities, or operational steps illustrated in FIGS. 1 to 5 should not be construed as essential components to practice the disclosure, and the disclosure may be rather implemented with only some of the components without departing from the gist of the disclosure.

The operations of the above-described embodiments may be implemented by providing a memory device storing a corresponding program code in any component of the device. In other words, the controller in the device may execute the above-described operations by reading and executing the program codes stored in the memory device by a processor or central processing unit (CPU).

As described herein, various components or modules in the entity, or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or ASICs.

Although specific embodiments have been described above, various changes may be made thereto without departing from the scope of the disclosure. Thus, the scope of the disclosure should not be limited to the above-described embodiments, and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

1. A method performed by a user equipment (UE) in a wireless communication system supporting a localized service, the method comprising:
transmitting, to an access and mobility management function (AMF) of a hosting network providing the localized service, a first message including information related to the localized service;
receiving, from the AMF, a second message including policy information related to the localized service, the policy information including information on a name of the localized service and UE route selection policy (URSP) rules related to the localized service; and
transmitting, to a session management function (SMF) via the AMF, a protocol data unit (PDU) session request message including information representing the localized service, based on the policy information.

2. The method of claim 1,
wherein the information related to the localized service includes at least one of the information on the name of the localized service and an indication or an reason that a request is to access the localized service, and
wherein the second message further includes a list of information related to localized services provided by the hosting network.

3. The method of claim 1, further comprising:
establishing a restricted PDU session for the localized service with a localized service provider (LSP) server; and
obtaining, from the LSP server, credentials required for the hosting network.

4. The method of claim 1, further comprising:
transmitting, to the AMF, a registration request message including at least one of an indication or an reason that a registration request is to access the localized service; and
receiving, from the AMF, a registration accept message including a list of information related to localized services provided by the hosting network.

5. The method of claim 4, further comprising selecting one of the localized services to transmit the first message including the information on the name of the localized service.

6. The method of claim 1, wherein the policy information includes an indication indicating whether providing the localized service via a restricted PDU session is allowed.

7. The method of claim 1:
wherein the first message includes a first non access stratum (NAS) message including the information related to the localized service, and
wherein the second message includes a second NAS message including the policy information, the policy information further including network address information of a captive portal through which the UE subscribes for the localized service.

8. A user equipment (UE) in a wireless communication system supporting a localized service, the UE comprising:
a transceiver; and
a processor configured to:
transmit, to an access and mobility management function (AMF) of a hosting network providing the localized service, through the transceiver, a first message including information related to the localized service,
receive, through the transceiver from the AMF, a second message including policy information related to the localized service, the policy information including information on a name of the localized service and UE route selection policy (URSP) rules related to the localized service, and
transmit, to a session management function (SMF) via the AMF, through the transceiver, a protocol data unit (PDU) session request message including information representing the localized service through the transceiver, based on the policy information.

9. The UE of claim 8,
wherein the information related to the localized service includes at least one of the information on the name of the localized service and an indication or an reason that a request is to access the localized service, and
wherein the second message further includes a list of information related to localized services provided by the hosting network.

10.-14. (canceled)

15. An access and mobility management function (AMF) of a hosting network providing a localized service in a wireless communication system, the AMF comprising:
a transceiver; and
a processor configured to:
receive, through the transceiver from a user equipment (UE), a first message including information related to the localized service,
transmit, to a policy and control function (PCF) through the transceiver, a policy request message including the information related to the localized service,
receive, through the transceiver from the PCF, a policy response message including policy information related to the localized service, the policy information including information on a name of the localized service and UE route selection policy (URSP) rules related to the localized service, and
transmit, to the UE through the transceiver, a second message including the policy information related to the localized service.

16. The AMF of claim 15, wherein the policy information further includes at least one of:
information on a captive portal through which the UE subscribes for the localized service, or
an indication indicating whether provisioning via a restricted PDU session is allowed.

17. The AMF of claim 15, wherein the processor is further configured to:
receive, through the transceiver from the UE, a registration request message including at least one of an indication or an reason that a registration request is to access the localized service, and
transmit, to the AMF through the transceiver, a registration accept message including a list of information related to localized services provided by the hosting network.

18. The AMF of claim 15, wherein the information related to the localized service includes at least one of:
the information on the name of the localized service, or
an indication or a reason that a request is to access the localized service,
wherein the second message further includes a list of information related to localized services provided by the hosting network, and
wherein the policy information includes an indication whether providing the localized service via a restricted PDU session is allowed.

19. A session management function (SMF) of a hosting network providing a localized service in a wireless communication system, the SMF comprising:
a transceiver; and
a processor configured to:
receive, from a user equipment (UE) via AMF, through the transceiver, a session establishment message including information related to the localized service,
transmit, to a policy and control function (PCF) through the transceiver, a policy request message including the information related to the localized service,
receive, through the transceiver from the PCF, a policy response message including policy information related to the localized service, the policy information including information on a name of the localized service, and
set up a restricted PDU session based on the policy information related to the localized service.

20. The SMF of claim 19, wherein the policy information further include at least one of:
a max duration of session, information on max data for a restricted PDU session, or
redirection information indicating an address of a captive portal through which the UE subscribes for the localized service.
